(19) United States
(12) Patent Application Publication
(10) Pub. No.: US 2011/0151060 A1
(43) Pub. Date: Jun. 23, 2011

(54) BEVERAGE EXTRACTION FILTER AND PRODUCTION METHOD THEREFOR

(75) Inventor: Osamu Nakagiri, Osaka (JP)

(73) Assignee: UCC UESHIMA COFFEE CO., LTD.,, TAKATSUKI-SHI, OSAKA (JP)

(21) Appl. No.: 13/059,953

(22) PCT Filed: Jun. 3, 2009
(86) PCT No.: PCT/JP2009/060116

§ 371 Date: Feb. 18, 2011

(30) Foreign Application Priority Data
Aug. 20, 2008 (JP) 2008212064
Nov. 7, 2008 (JP) 2008286861

(51) Int. Cl. B65B 29/02; B65D 81/34; B29C 67/20

(52) U.S. Cl. 426/77; 426/394; 264/294

(57) ABSTRACT

Provided is a beverage extraction filter for use in a beverage extraction apparatus, wherein costs can be reduced, and the filter is not bulky during transportation and can be discarded easily. The beverage extraction filter to be set in the predetermined position of the beverage extraction apparatus is provided with a filter section (10), in which an article of taste is to be contained, and a flat cover section (11) to be attached to the upper portion of the filter section (10). Bellows are formed in the vicinity of the upper portion of the filter section (10) such that the bellows of the bellows section stretch after the filter is set in the predetermined position and hot water is poured through the cover section.

### TECHNICAL FIELD

The present invention relates to a beverage use extraction filter which is set to a predetermined position of a beverage use extraction device, and a manufacturing method of the same.

### BACKGROUND ART

In nonessential grocery items such as coffee, black tea, green tea and the like, a hot coffee, a hot black tea and the like can be made by accommodating powdered material thereof in a beverage use extraction filter, setting to a predetermined position of the beverage use extraction device, and pouring a hot water from an upper portion. The beverage use extraction device in which the beverage use extraction filter is set is mainly used for business use, however, a downsized structure which can be used for home becomes popular.

With regard to the beverage use extraction filter and the beverage use extraction device, there has been known an extraction device for a coffee or the like disclosed in the following patent document 1. In this extraction device, a cartridge in which powdered nonessential grocery items are accommodated is used. The cartridge is formed by a container made of resin, and a filter portion is accommodated in an inner portion of the container. An upper portion of the container is sealed by a lid portion. The lid portion is formed by a sheet made of a film.

At a time of extracting the coffee or the like, a hot water is poured by making a hot water pouring needle pass through from the lid portion in the upper portion of the cartridge or directly from the lid portion in the upper portion. Further, an extracting needle is passed through from a bottom portion of the cartridge. Accordingly, the nonessential grocery items are extracted from the cartridge, and can be poured into a coffee cup or the like which is mounted to a lower portion of the cartridge.

### PRIOR ART DOCUMENT

### Patent Document

Patent Document 1: Japanese Unexamined Patent Publication No. 2005-110835

### SUMMARY OF THE INVENTION

### Problems to Be Solved By the Invention

The problem in the prior art mentioned above is as follows. Since the cartridge accommodating the nonessential grocery items is structured such that the filter is provided in the inner portion of the resin container, the cost of the cartridge had a limit for reducing. Further, the container made of resin has a limit for making a size small, and there is also a problem that it becomes bulky at a time of packaging and transporting. Further, it is necessary to sort the cartridge using the resin container by a resin part and a paper part at a time of disposing, and it is troublesome.

The present invention is made by taking the actual condition mentioned above into consideration, and an object thereof is to provided a beverage use extraction filter used in a beverage use extraction device, provided with a structure which can reduce a cost thereof, is not bulky at a time of transporting, and in which a disposition process can be easily carried out, and a manufacturing method of the same.

### Means for Solving the Problem

In order to solve the above mentioned problems, in accordance with the present invention, there is provided a beverage use extraction filter set at a predetermined position of a beverage use extraction device, the beverage use extraction filter comprising:

a filter portion in which nonessential grocery items are accommodated; and

a tabular lid portion attached to an upper portion of the filter portion,

wherein a bellows portion is formed in the vicinity of an upper portion of the filter portion, and a bellows in the bellows portion extends after it is set at the predetermined position and a hot water is poured via the lid portion.

A description will be given of an action and an effect of the beverage use extraction filter on the basis of this structure. The filter is constructed by a filter portion in which the nonessential grocery items are accommodated, and the tabular lid portion attached to the upper portion of the filter portion. At a time of carrying out the extraction of the nonessential grocery items, the hot water is poured by making the hot water pouring needle pass through from the lid portion. Alternatively, the hot water is poured directly from the lid portion in the upper portion. The extracted nonessential grocery items are poured out of the filter portion, and are poured into the cup or the like as they are. The container made of resin is not used, and a cost can be reduced at that degree. Further, since the container made of resin is not necessary, a sorting work is not necessary at a time of disposing.

Further, the bellows portion is provided in the upper portion of the filter portion, and it is possible to keep a state in which the bellows portion is formed, until it is set to the device. Accordingly, it is possible to prevent it from being bulky at a time of transporting or the like. At a time of carrying out the extraction of the nonessential grocery items, a space is necessary in an upper portion of the portion in which the nonessential grocery items are accommodated, in the inner portion of the filter portion, however, if the extraction is started by pouring the hot water, the bellows portion extends and the space is formed, on the basis of a hot water pouring force or an action of a gravitational force. This space is necessary for the nonessential grocery items inflated by the hot water and the hot water to stay so as to come into contact with each other. Accordingly, it is possible to carry out a sufficient extraction.

In the present invention, it is preferable that the number of stages of the bellows is at least two stages. It is possible to reduce a height of the filter by forming the bellows having at least two stages, and it is possible to form a space having an appropriate magnitude at a time of carrying out the extraction.

In the present invention, it is preferable that the filter portion is formed as a bowl shape, and the lid portion has a flange portion having a larger diameter than an outer diameter of an upper portion of the bowl shape, and a grip portion further protruding out of the flange portion.

According to this structure, the lid portion has the flange portion having the larger diameter than the filter portion formed as the bowl shape. The lid portion can be mounted to a predetermined position of the beverage use extraction device using the flange portion. Further, since the grip portion is integrally formed, it is possible to remove the filter after extraction from the predetermined position while holding the grip portion with a hand, for example.

In the present invention, it is preferable that the lid portion is formed by an nonwoven fabric. Accordingly, it is possible to pour the hot water without inserting the hot water pouring needle from the lid portion. Further, the lid portion in accordance with the present invention can be formed by a laminate film, and at least one layer can be constructed by non water permeable resin film having a sealability. In the case of the lid portion mentioned above, it is possible to pour the hot water by inserting the hot water pouring needle from the lid portion.

In order to solve the above mentioned problem, in accordance with the present invention, there is provided a manufacturing method of the beverage use extraction filter, the method comprising:

a step of forming the filter portion having the bowl shape from a sheet-like raw material; and

a step of forming the bellows portion in the vicinity of the upper portion of the filter portion.

A description will be given of an action and an effect of the manufacturing method of the beverage use extraction filter. First of all, the filter portion having the bowl shape is formed from the sheet-like raw material. As the raw material, for example, a spunbonded nonwoven fabric which is excellent in a formability can be used. Next, the bellows portion is formed in the vicinity of an upper portion of the bowl shape. Accordingly, the filter portion having the bellows portion is produced. In accordance with the structure mentioned above, as mentioned above, it is possible to reduce the cost, and it is possible to manufacture the beverage use extraction filter provided with the structure which is not bulky at a time of transporting and in which the disposing process can be easily carried out.

In the present invention, it is preferable to have a step of filling the nonessential grocery items in the inner portion of the filter portion in which the bellows portion is formed, a step of putting the lid portion after filling the nonessential grocery items, and a step of packaging the beverage use extraction filter by a wrapping paper while keeping a state in which the bellows portion is formed.

When filling the nonessential grocery items in the filter portion in which the bellows portion is formed, the nonessential grocery items are filled in a state in which the bellows is formed. The sealing is carried out by the lid portion after filling, and a whole of the filter is further packaged by the wrapping paper. The packaging is carried out in a state in which the bellows is formed. Accordingly, it is possible to prevent the filter from being bulky at a time of transporting a lot of filters.

In the present invention, it is preferable that the sheet-like raw material is constructed by a nonwoven fabric having a shape memory characteristic by a heat forming.

As the raw material mentioned above, for example, a spunbonded nonwoven fabric can be used. There is applied such a force that the bellows portion comes back to the bowl shape before the bellows portion is formed, on the basis of a temperature of the hot water at a time of pouring the hot water when extracting the nonessential grocery items, by using the raw material having the shape memory characteristic by the heat forming, and it is possible to easily and securely form the stay space mentioned above.

In the present invention, it is preferable that the step of forming the bellows portion is carried out while keeping the height of the bowl shape.

Since the bellows portion is formed while keeping the height of the filter portion formed as the bowl shape, the thickness of the bellows portion becomes thinner in comparison with the other portions. Accordingly, it is possible to make a fold and an elongation of the bellows portion be easily achieved.

In the present invention, it is preferable that the forming step of the filter portion and the forming step of the bellows portion are carried out under a higher temperature environment than a hot water pouring temperature at a time of extracting the nonessential grocery items.

It is possible to appropriately form the filter portion having the bowl shape and the bellows portion, by carrying out the formation under the temperature set. Further, at a time of extracting the nonessential grocery items, it is possible to set a state in which the bellows portion is elongated, on the basis of an action of the hot water pouring force and the gravitational force.

In the present invention, it is preferable that the forming step of the filter portion is carried out under a higher temperature environment (for example, 150° C.) than the hot water pouring temperature (for example, 100° C.) at a time of extracting the nonessential grocery items, and the forming step of the bellows portion is carried out under a lower temperature environment (for example, 60° C.) than the hot water pouring temperature.

Since the formation of the filter portion is carried out under the temperature environment mentioned above, there is applied the force that the bellows portion is going to be returned to the bowl shape before being formed, on the basis of the characteristic of the nonwoven fabric having the shape memory characteristic on the basis of the heat forming, by pouring the hot water at a time of extracting the nonessential grocery items, and it is going to be returned to the shape with no bellows portion. Accordingly, it is possible to form the stay space.

### BRIEF DESCRIPTION OF THE DRAWINGS

FIG. 1 is a perspective view showing an outer appearance structure of a coffee extraction device;

FIG. 2 is a view showing a state in which a filter set portion is pulled out;

FIG. 3 is a view showing a structure of a filter;

FIG. 4 is a view showing a sheet-like member producing the filter;

FIG. 5 is a view showing a manufacturing step of the filter (a first embodiment);

FIG. 6 is a plan view showing a structure of a two-piece semicircular block in FIG. 5;

FIG. 7 is a view showing an extracting step of a coffee (a first embodiment)

FIG. 8 is a view showing a manufacturing step of the filter (a second embodiment);

FIG. 9 is a view showing an extracting step of the coffee (a second embodiment);

FIG. 10 is a view showing a packaging step of a filter product; and

FIG. 11 is a view showing a structure of a female die block.

### MODE FOR CARRYING OUT THE INVENTION

A description will be given of a preferable embodiment of a beverage use extraction filter in accordance with the present invention with reference to the accompanying drawings. Specifically, a description will be given of an embodiment of a coffee extraction filter (hereinafter, referred simply to as “filter”) for extracting a coffee or the like (coffee, black tea, green tea or the like). First of all, a description will be briefly given of a structure of a coffee extraction device (hereinafter, referred simply to as “extraction device”) in which the filter in accordance with the present invention is used.

<Structure of Coffee Extraction Device>

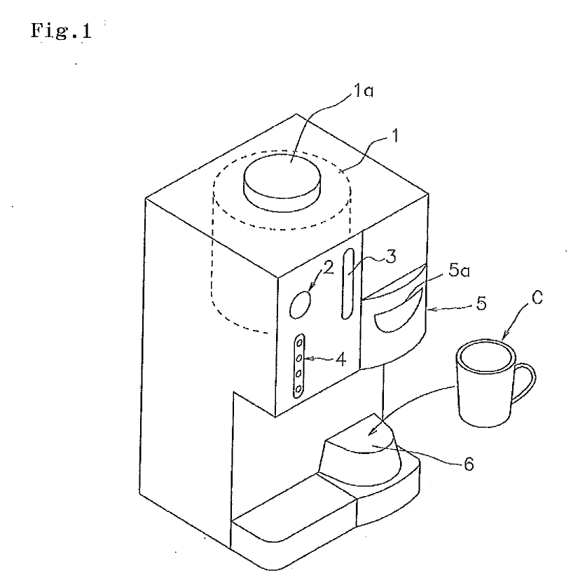

FIG. 1 is a perspective view showing an outer appearance structure of the extraction device. The extraction device is provided with a heating and heat insulating type hot water reservoir container 1, a motor-driven pump, an extraction mechanism, a hot water passage pipe, a hot water pouring needle and the like which are not illustrated. The hot water within the hot water reservoir container 1 is fed to the hot water pouring needle by the motor-driven pump. The hot water pouring needle is positioned above a lid portion of the filter, and is actuated in such a manner that a leading end of the hot water pouring needle passes through the lid portion.

A front surface side of the extraction device is provided with a control portion or the like which a user operates. A start button 2 is structured such that an extraction motion is started by pushing this. A water amount display portion 3 displays exteriorly a water amount level within the hot water reservoir container 1. In the case that the water decreases, it is possible to replenish the water via a pouring port la provided in a ceiling surface of the device. An extraction state display portion 4 visually displays an extraction state. The user can determine whether or not the extraction is finished, by viewing the extraction state display portion 4.

A filter set portion 5 is a position to which the filter in accordance with the present invention is set. It is structured of a drawer type, and the filter set portion 5 can be pulled to a near side by putting a hand in a concave portion 5a. A cup C is mounted on a mounting portion 6.

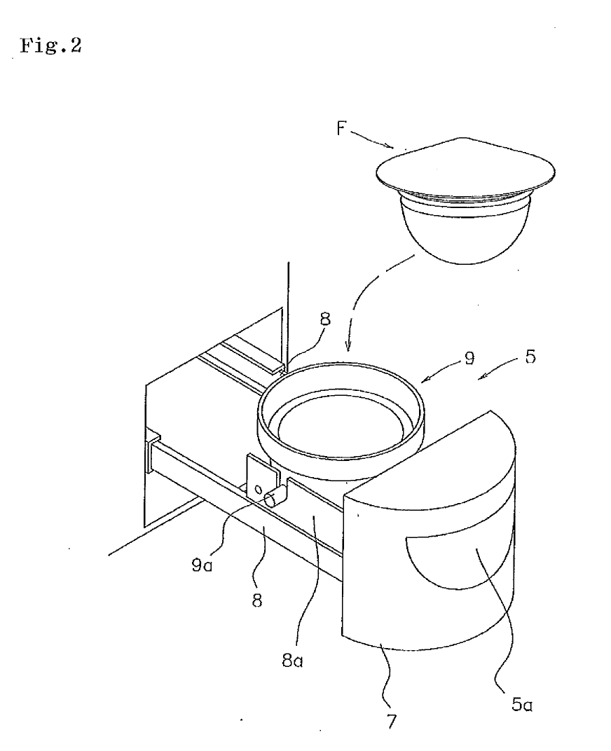

FIG. 2 is a perspective view showing a structure of the filter set portion 5, and shows a pulled out state. An outer appearance cover member 7 is held by a pair of right and left guide rails 8 so as to be slidable in a longitudinal direction. A set container 9 for setting a filter F to a predetermined position is held. An upper end portion of the set container 9 is a mounting surface on which the filter F is mounted, and corresponds to the predetermined position. The set container 9 is integrally provided with a holding pin 9a, and is held to a holding plate 8a attached to the guide rail 8.

The set container 9 is rotatably held by the holding pin 9a, and the filter F which is not necessary after the extraction is finished, is forcibly dropped from the set container 9 by rotating the set container 9 by a mechanism (not shown), thereby being recovered within a recovery box (not shown).

<Structure of Filter>

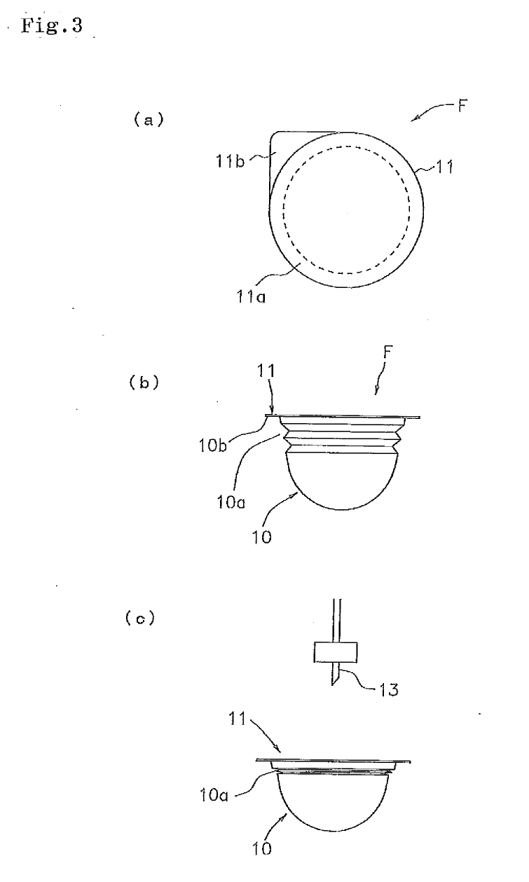

FIG. 3 is a view showing a structure of the filter F. FIG. 3(a) is a plan view, (b) is a side elevational view of a state in which the bellows is elongated, and (c) is a side elevational view of a state in which the bellows is folded. In this case, FIG. 3 illustrates the filter F which is manufactured by a manufacturing method in accordance with the first embodiment mentioned below.

As illustrated, the filter F is constructed by a filter portion 10 and a lid portion 11. The filter portion 10 is formed by a nonwoven fabric, however, a spunbonded nonwoven fabric (trade name “smash”) of ASAHI KASEI FIBERS CORPORATION is preferably used. This raw material is a special polyester continuous fiber nonwoven fabric, has a thermoplastic feature, is easily deformed by being heated, and such a feature that a hot press molding work can be applied. Further, it is excellent in a point of a durability against a hot water temperature, and can be stably extracted.

The filter portion 10 is formed as a bowl shape (or a semielliptic shape or a semioval shape) in its entire shape. A bottom portion thereof has such a shape as to draw a gentle curve. An outer diameter dimension of the upper portion is φ45 mm, for example, and a flange portion 10b is integrally formed for bonding to the lid portion 11. An outer diameter dimension of the flange portion 10b is φ55 mm.

A bellows portion 10a is formed in the vicinity of the upper portion of the filter F. The bellows portion 10a has two stages of valley portions, and is formed at a pitch 5.0 mm. Accordingly, an entire length of the bellows portion 10a is 10 mm in a state in FIG. 3(b). The bellows portion 10a is formed from a position (corresponding to the vicinity of the upper portion) which is 3 mm downward from a position of the lid portion 11. In other words, a formed range of the bellows portion 10a is between 3 mm and 13 mm which is downward from the position of the lid portion 11. A numerical value setting of 3 mm mentioned above is not limited to this, but may be set to about several mm, for example.

The bellows portion 10a is held in a folded state, as shown in FIG. 3(c), until the extraction of the coffee is carried out. When the hot water is poured from the upper portion, the bellows portion 10a comes to an elongated state, as shown in FIG. 3(b), on the basis of a hot water pouring force and an action of a gravitational force. In a state in which the bellows portion 10a is folded, coffee powders are filled in an inner portion of the filter portion 10 approximately with no gap. When the bellows portion 10a is elongated, a space is formed in an upper portion of the filled coffee. In order to form the space mentioned above, the bellows portion 10a is formed in the vicinity of the lid portion 11.

The space is called as a stay space, and is a space where the coffee powder inflated by moisture after pouring the hot water and the hot water stay and come into contact with each other. In the case that the space is not provided, an appropriate stay and contact is not carried out. Accordingly, a weak coffee is extracted. Therefore, the stay space is necessary for extracting a savory coffee.

A shape of the lid portion 11 is formed as a tabular shape (or a sheet shape) as shown in FIG. 3(a). The lid portion 11 has a flange portion 11a, and has the same outer diameter dimension as the flange portion 10b of the filter portion 10. Further, a grip portion 11b is integrally formed. When setting the filter F to the extraction device so as to extract the coffee, and removing the extracted filter F, it can be carried out by holding the grip portion 11b by a hand.

A raw material of the lid portion 11 is preferably a laminated resin film. For example, a three-layer laminated film of a rayon, a polyethylene terephthalate (PET) and a straight chain low density polyethylene (LLDPE) or a two-layer laminated film of the rayon and a bidirectional oriented polypropylene (CP) is preferable. These raw materials are all non water permeable resin film having a sealability. In this case, the other materials can be appropriately used as far as having the non water permeability.

It is necessary to form a through hole in the lid portion 11 by a hot water pouring needle, and a certain level of shape holding power is necessary for bonding the flange portion 11a of the lid portion 11 and the flange portion 10b of the filter portion 10. Further, if a shock resistance of the lid portion 11 is too large for making the hot water pouring needle to pass through, it becomes hard for the needle to pass through. In other words, a size of the hot water pouring needle is φ5 mm, and it is necessary to easily form a hole. In this case, if it is too weak, there is a possibility that the raw material breaks off at a time of a penetrating motion.

Further, after passing through the hot water pouring hole, in order to pour the pressurized hot water, a hydrophobic raw material is demanded in such a manner as to prevent the hot water from leaking from the lid portion 11. Further, the laminated outermost armor is preferably formed as a paper like finish outer appearance and made of a raw material making feel utilization of a natural raw material, for creating such an atmosphere as to take an environment into consideration.

The rayon can be formed as the nonwoven fabric by chemically decomposing a natural cellulose so as to form a fiber type. The CP has a low temperature sealing performance and is an inexpensive raw material. The LLDPE has a low temperature sealability, and has such a nature as to penetrate into the nonwoven fabric of the filter portion 11. A heat seal can be achieved by using the LLDPE. In this case, the heat seal can be achieved by the CP, however, when sealing the nonwoven fabric, an ultrasonic seal is generally necessary since a thermal conductivity of the nonwoven fabric is inferior.

In other words, in the case of selecting the raw material as the raw material of the lid portion 11, the LLDPE or the CP existing the lowest layer of the laminate serves as the seal material, in the adhesion to the filter portion 10. In the case of adhering, a gelatinized resin penetrates into the fiber in the filter portion 10 by applying the heat to the raw material so as to gelatinize, thereby being solidified after being cooled, and the adhesion is completed.

The PET is used for holding a hardness of the lid portion 11 and for enhancing an unsealability at a time of piercing by the hot water pouring needle. Further, it is used for the purpose of securing a pressure tightness against the pressurized hot water at a time of extracting. The LLDPE has a good drawing property and tends to be elongated.

<Manufacturing Step of Filter (First Embodiment)>

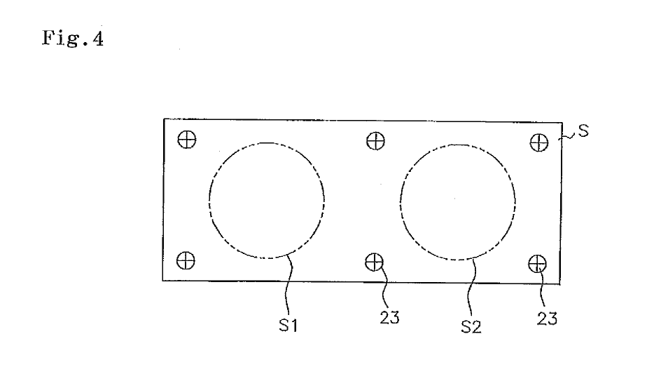

Next, a description will be given of a manufacturing step (a first embodiment) of the filter in accordance with the present invention. FIG. 4 shows a plan view of a sheet S before being shaped. The sheet S has a rectangular shape, and is held by holding members 23 at six positions. Further, since the sheet S can be easily shaped by being preheated, it is previously heated to about 50° C. to 80° C. Positions at which a holding formation is carried out by a heater block 21 mentioned below are denoted by reference symbols S1 and S2. Accordingly, in the embodiment shown in FIG. 4, two filters are produced from one sheet S. The raw material of the sheet S can employ a spunbonded nonwoven fabric (trade name “smash”) as mentioned above.

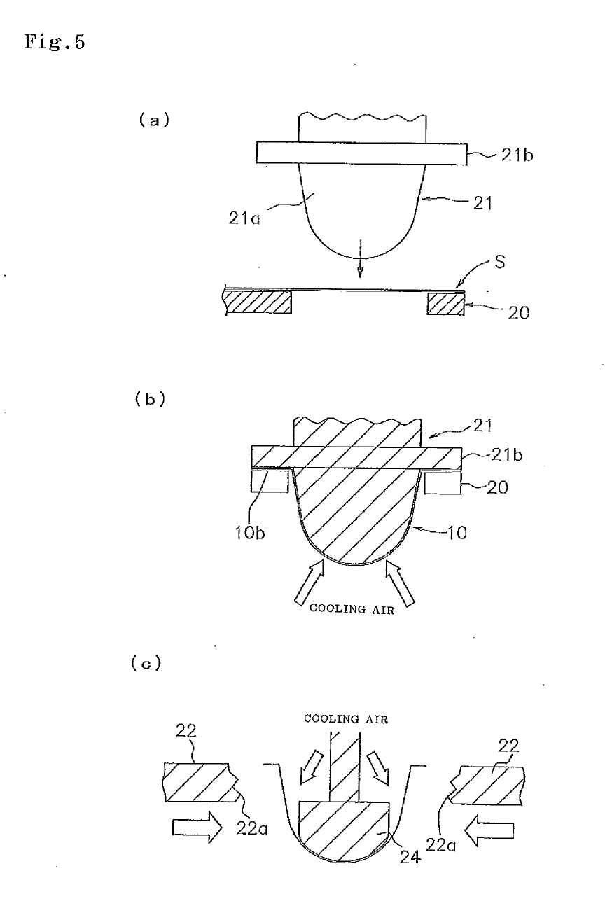

FIG. 5 shows a step of producing the filter portion 10 by using the sheet S shown in FIG. 4. First of all, as shown in FIG. 5(a), a rectangular formed sheet S is mounted on a lower mold 20. A shape of the lower mold 20 is structured such that holes corresponding to S1 and S2 shown in FIG. 4 are formed in a rectangular plate. A male type heater block 21 has a main body portion 21a which has a bowl shape, and a flange portion 21b which is integrally provided in an upper portion of the main body portion 21a. A heater mechanism is provided in an inner portion of the main body portion 21a. The heater block 21 is heated to 150 to 180° C.

A basic shape of the filter portion 10 is formed, as shown in FIG. 5(b), by moving down the male type heater block 21 from the above. An outer peripheral portion of the sheet S is pinched by the lower mold 20 and the flange portion 21b of the heater block 21, whereby the flange portion 10b of the filter portion 10 is formed. The spunbonded nonwoven fabric mentioned above is a raw material which is easily hot formed, and is easily formed in a bowl shape, by being set to a state of being heated to 150 to 180° C. by the heater block 21.

Further, after forming the bowl shape, a cooling air is sprayed from the below. Thereafter, the heater block 21 is pulled upward.

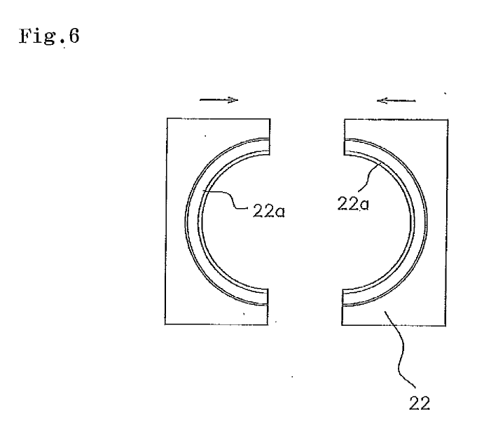

Next, a two-piece semicircular block 22 is used, as shown in FIG. 5(c), for forming the bellows portion 10a. At this time, the flange portion 10b of the filter portion 10 formed as the bowl shape is supported by a mechanism (not shown). A pair of right and left semicircular blocks 22 are provided as illustrated, and a chevron projection 22a for forming the bellows portion 10a is formed in an end surface thereof. In this case, a plan view of the two-piece semicircular block 22 is shown in FIG. 6.

At a time of forming the bellows portion 10a, a holding block 24 is inserted after getting out the heater block 21. A height of the bowl shape formed by the heater block 21 is 33 mm, however, the holding block 24 is inserted in such a manner that the height 33 mm is maintained. During the holding by the holding block 24, a cooling air is fed in an inner portion, in the same manner as the case of the heater block 21.

The two-piece semicircular block 22 is characterized in that the bellows portion 10a is formed while heating at a low temperature between 150 and 180° C. in the same manner as the heater block 21. Since the bellows portion 10a is formed while maintaining the height by the holding block 24, the formed bellows portion 10a becomes thinner in its thickness than the other portions except for the bellows portion 10a. Therefore, the bellows portion 10a can be easily folded.

<Extracting Step (First Embodiment)>

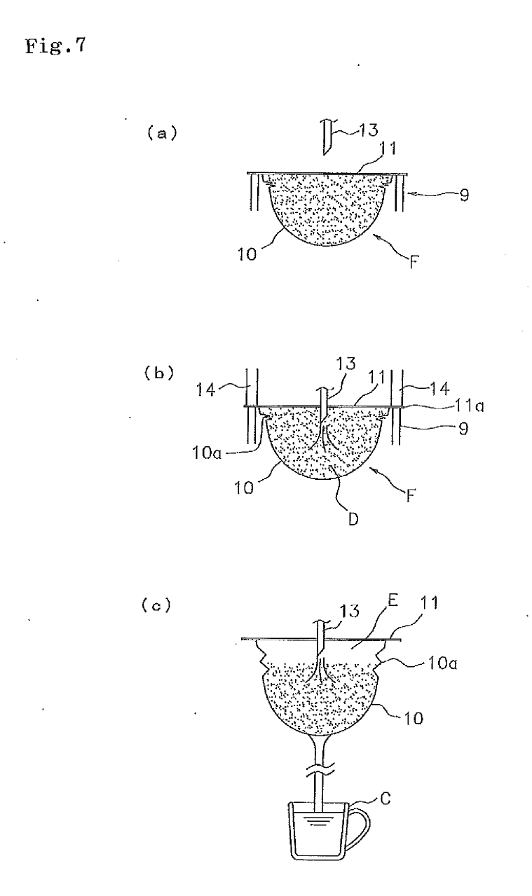

Next, a description will be given of a procedure at a time of extracting the coffee by the filter which is produced by the manufacturing method in accordance with the first embodiment with reference to FIG. 7. In the extracting device described with reference to FIGS. 1 and 2, the filter set portion 5 is drawn out (FIG. 2). Further, the wrapping paper 12 is unsealed, and the filter F is set on the set container 9 (at a predetermined position). Next, the filter set portion 5 is closed. This state is shown in FIG. 7(a). At this time, the hot water pouring needle 13 stands ready above the lid portion 11.

The hot water pouring needle 13 comes down from the above by pushing the start button 2, and the leading end portion thereof breaks the lid portion 11 so as to make an intrusion into the inner portion of the filter F (refer to FIG. 7(b)). Next, the hot water is poured from the hot water pouring needle 13. In this case, at this time, since the flange portion 11a of the lid portion 11 is held down by the holding member 14, it is possible to securely break the lid portion 11 by the leading end of the hot water pouring needle 13.

The hot water stays in the inner portion of the filter F as shown in FIG. 7(c) with being poured, and the folded bellows portion 10a is elongated on the basis of an action of the hot water pouring force and the gravitational force. Accordingly, a stay space E is formed in an upper portion of the filter F. This is a space where the coffee powder which is inflated by the moisture after pouring the hot water, and the hot water stay so as to come into contact. In the case that the stay space E is not formed, an appropriate stay contact is not carried out, and a weak coffee is extracted. Accordingly, in order to extract a savory coffee, the stay space E is necessary.

According to the filter F in accordance with the present invention, since the stay space E is not formed in a state in which the filter F is packaged, it is possible to keep the filter F in a small size. On the other hand, at a time of carrying out the extraction of the coffee, the stay space E is formed along with the hot water pouring motion. Therefore, it is possible to extract a savory coffee in the same manner as the conventional one.

An amount of the hot water which is poured from the hot water pouring needle 13 is previously set, and a predetermined amount of extracted coffee is poured into the cup C. Since the filter F according to the present invention is not provided with the resin container, a needle for extraction is not necessary in a bottom portion.

When the extraction is finished, the hot water pouring needle 13 rises, and turns back to a standby position. The extracted filter F is moved to a waste box by a mechanism (not shown).

<Manufacturing Step of Filter (Second Embodiment)>

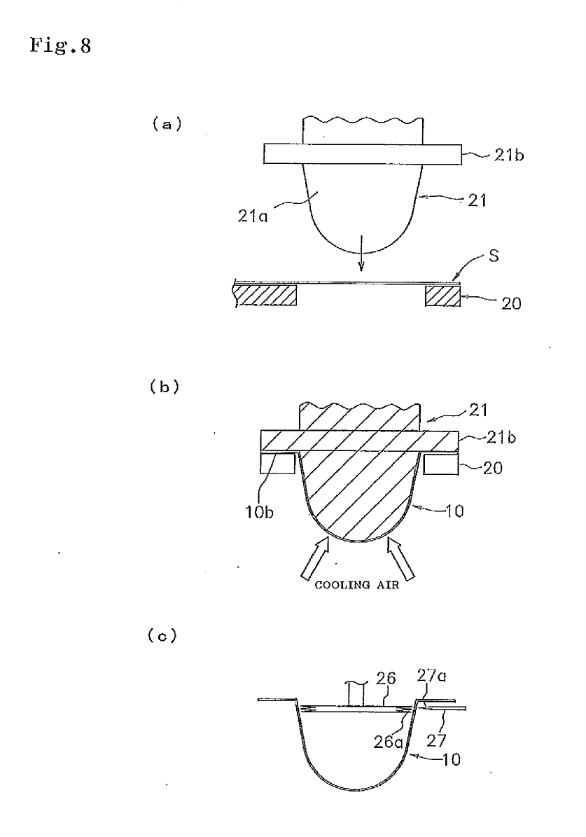

Next, a description will be given of a manufacturing step (a second embodiment) of the filter in accordance with the present invention with reference to FIG. 8. A point that the sheet S shown in FIG. 4 is used is the same as the above mentioned embodiments. In FIG. 8, since the steps (a) and (b) are the same as the first embodiment, a description thereof will be omitted. The description of the raw material of the sheet S is also omitted with the same reason of the above.

As shown in FIG. 8(c), after forming the bowl-shaped filter portion 10, an inner mold 26 is inserted to an inner portion of the filter portion 10. A forming groove 26a for forming the bellows portion is formed in an outer periphery of the inner mold 26. The forming groove 26a is formed in two stages. The inner mold 26 is set at a room temperature.

A groove forming mold 27 is arranged in an outer side of the filter portion 10. A leading end portion 27a is formed in the groove forming mold 27, and the bellows portion 10a is formed by pressing it to the forming groove 26a. The groove forming mold 27 may employ the two-piece metal mold as shown in FIG. 6, however, may form the bellows portion 10a by being formed as a disc shape (a forming roller) and rotating an outer periphery of the inner mold 26 while pressing the disc to the inner mold 26. In the embodiment in FIG. 8(c), a lower stage groove may be formed after forming an upper stage groove. As a matter of course, upper and lower two stages of leading end portions 27a may be provided in the groove forming mold 27, in order to allow two stages of grooves to be formed at a single stroke.

A pitch of the grooves in the leading end portion 27a of the groove forming mold 27 is smaller than a pitch of the grooves of the chevron projection 22a of the two-piece semicircular block shown in FIG. 5(c). For example, the groove pitch of the leading end portion 27a is 2.5 mm (a length of the formed bellows portion 10a is 5 mm), and is set to about half of the case in FIG. 5(c).

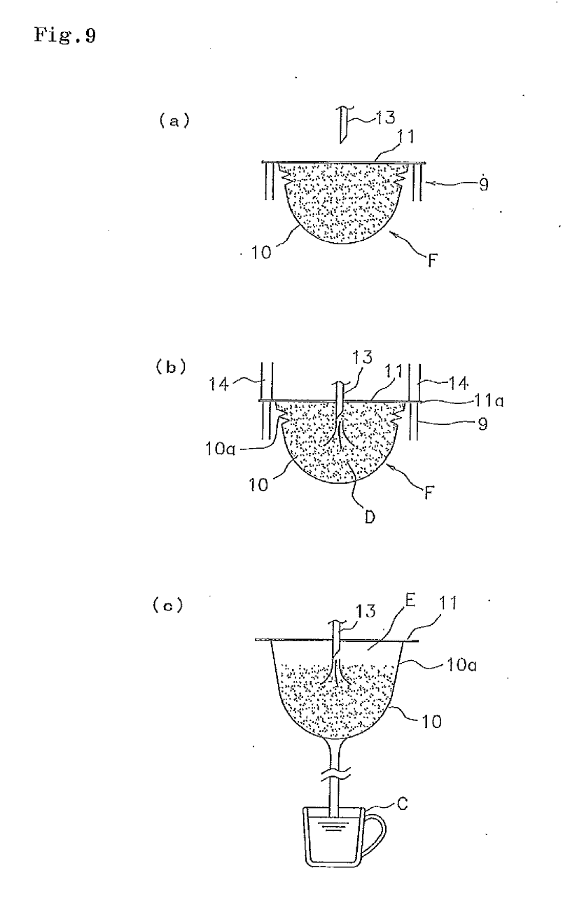

The groove forming mold 27 is set at 60° C. (a lower temperature than the hot water pouring temperature). The temperature is set at as mentioned above for utilizing a shape memory characteristic caused by the hot forming included in the filter raw material. In other words, such a force that the bellows portion 10a is going to turn back to the original shape is actuated by pouring the hot water which is close to 100° C. as shown in FIG. 9. Accordingly, it is possible to easily elongate the bellows portion 10a. In this case, 60° C. of the groove forming mold 27 is a lower temperature (a low temperature) than the temperature (100° C.) of the holt water, and 150° C. to 180° C. of the heater block 21 is a higher temperature than the hot water temperature. It is possible to make good use of the shape memory characteristic of the raw material, by setting the temperature as mentioned above. Accordingly, the temperature setting of 60° C. and between 150° C. and 180° C. can be changed within a range which can achieve the object mentioned above. The shape of the filter portion 10 produced as mentioned above is shown in FIG. 9.

In the case of FIG. 8, since the holding block 24 shown in FIG. 5 is not provided, the thickness of the bellows portion 10a does not become thin even by forming the bellows portion 10a. In this case, a total height of the bowl shape becomes lower by forming the bellows portion 10a.

<Extracting Step (Second Embodiment)>

A description will be given of a procedure at a time of extracting the coffee by using the filter which is produced by the manufacturing method in accordance with the second embodiment with reference to FIG. 9. FIG. 9(c) is greatly different from the extracting step shown in FIG. 7.

When the hot water is poured into the inner portion of the filter F, a force that the bellows portion 10a is going to turn back to the shape before being formed, is actuated on the basis of the shape memory characteristic of the raw material. Accordingly, the stay space E is formed in the upper portion of the filter F.

<Packaging Step (First and Second Embodiments)>

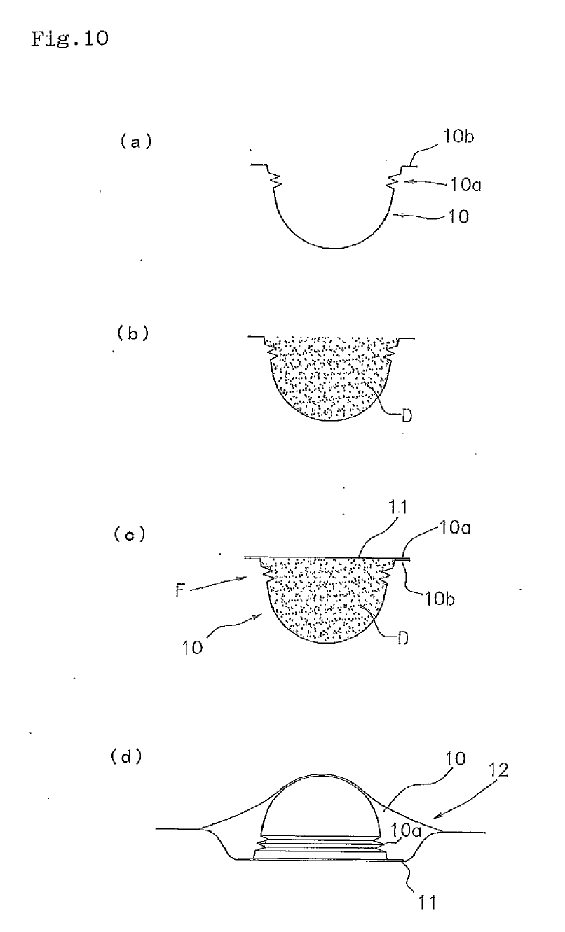

Next, a description will be given of a step of packaging the coffee powder after filling with reference to FIG. 10. As shown in FIG. 10(a), the bellows portion 10a of the filter portion 10 is set in a folded state (the case of the filter in accordance with the manufacturing method of the first embodiment). In this connection, in the case of the manufacturing method in accordance with the second embodiment, since a pitch of the bellows portion 10a is smaller in comparison with the first embodiment, the step of folding the bellows is not necessary.

Next, as shown in FIG. 10(b), the coffee powder D is filled in the inner portion of the filter portion 10. At this time, the coffee powder D is filled in such a degree as to be filled up in an internal capacity of the filter portion 10 (such a degree that no gap is generated as illustrated).

At this time, it is preferable to fill the filter portion 10 while applying a compression to the coffee powder with a tamping. Accordingly, it is possible to raise the hardness of the filled portion, and it is possible to prevent the bellows 10a from elongating in a state of being packaged by a wrapping paper. Further, it is possible to make the filter F hard to be depressed even if an external pressure is applied to the filter F.

Next, the filter portion 10 is sealed by covering the lid portion 11. At this time, the flange portion 10b of the filter portion 10 is bonded to the flange portion 11a of the lid portion 11.

After the adhesion of the lid portion 11 is finished, the packaging by the wrapping paper 12 is carried out by setting the filter F vertically inversely as shown in FIG. 10(d). An amount of an air (an oxygen) is reduced by pouring a nitrogen into the inner portion of the wrapping paper 12. Accordingly, the external force is hard to be applied to the filter F by inflating a bag. Further, it doubles as prevention of a quality deterioration due to an oxidation of the coffee.

Further, the oxygen is hard to enter into the inner portion of the filter F, by packaging as mentioned above, and a quality is not deteriorated. For example, in the case that it is not packaged by the wrapping paper 12, if the adhesion is carried out while holding the coffee powder in the adhesion portion between the filter portion 10 and the lid portion 11, the oxygen enters into the inner portion from a gap of the adhesion portion, and a quality is deteriorated. However, in the case of the present invention, since the packaging is carried out by the wrapping paper 12 in a state in which the oxygen is lean in the inner portion, the problem as mentioned above is not generated, even if any defect exists in the adhesion portion.

In the packaging finish state, the filter F is packaged in a state in which the bellows portion 10a is formed. Further, if it is intended to elongate the bellows portion 10a, the bellows portion 10a cannot be easily elongated, since the nitrogen gas is poured and inflated as mentioned above. Accordingly, the state in which the bellows 10a is folded can be maintained, after packaging.

<Packaged State of Filter (First and Second Embodiments)>

Next, a description will be given of a packaged state of the filter F with reference to FIG. 10(d). As illustrated, it is packaged by the wrapping paper 12 in a state in which the bellows portion 10a is formed. In the case of the filter F in accordance with the first embodiment, the height of the filter F in a state in which the bellows portion 10a is elongated is 33 mm, however, the height comes to 25 mm by being folded. Further, in the case of the filter F in accordance with the second embodiment, the height of the formed filter F already comes to about 25 mm. Accordingly, it is possible to make the height dimension small, and it is possible to prevent from being bulky at a transportation, a storage and the like.

A dimension of the wrapping paper 12 is a square of 110 mm×110 mm in a plan view (a case of a four sided seal), or a rectangle of 90 mm×120 mm (a case of a three sided seal). The height dimension in the packaged state is 27 mm. Since the filter portion 10 and the lid portion 11 do not have an oxygen barrier characteristic and a moisture barrier characteristic, it is preferable that the packaging raw material employs a laminate film (for example, an aluminum deposition film) having a barrier characteristic. As a matter of course, the dimension of the wrapping paper 12 is not limited to the above, but may appropriately set.

<Other Embodiments of Lid Portion Material>

The material of the lid portion 11 described in the present embodiment is the laminated resin film, however, is not limited to this. For example, a single layer structure constructed only by a nonwoven fabric may be employed. Accordingly, it is possible to infiltrate the hot water to the inner portion of the filter, only by pouring the hot water from the above of the lid portion 11. As mentioned above, with regard to the filter of such a type that the hot water pouring needle is not inserted from the above, the present invention can be applied.

### OTHER EMODIMENTS

The beverage use extraction filter according to the present invention is not limited to the coffee use (including a regular coffee, an instant milk coffee and the like), but can be applied to the other appropriate nonessential grocery items such as a black tea, a cocoa, a green tea, an oolong tea and the like.

The specific shape of the bellows portion can be variously changed. For example, the number of the peaks and troughs of the bellows can be appropriately changed. Further, a depth of the peaks and troughs can be appropriately changed. Further, the stage number of the bellows can be appropriately set by taking into consideration the magnitude, the material and the like of the filter.

In the present invention, the filter portion has the bowl shape, however, the bowl shape is not limited to the shape formed only by the curves as shown in FIG. 3. It may have an angled shape. Long and short of it is that it has such a shape that can fill the nonessential grocery items in the inner portion.

The spunbonded nonwoven fabric is used as the raw material of the filter portion, however, it is not limited to the above as long a raw material has a molding workability and a shape memory characteristic, and various raw materials can be used.

In the present invention, “state in which the bellows is folded” does not indicate only a state in which it is completely folded, that is, a state in which the peaks and troughs are completely attached closely. Further, “state in which the bellows is elongated” does not indicate only a state in which it is completely elongated. The expressions “state in which the bellows is folded” and “state in which the bellows is elongated” are provided for expressing a relative relationship from first to last. They express the state in which the bellows is elongated so as to become long, and the state in which the bellows is contracted so as to become short, respectively.

In the present embodiment, the description is given of the actual example that two filters are produced from the rectangular sheet of one nonwoven fabric, with reference to FIG. 4. It is possible to appropriately set the number of filters which are produced from one sheet. Further, the sheet shape is not limited to the rectangular shape, but various modified examples such as a circular shape, a square shape, an oval shape and the like can be considered.

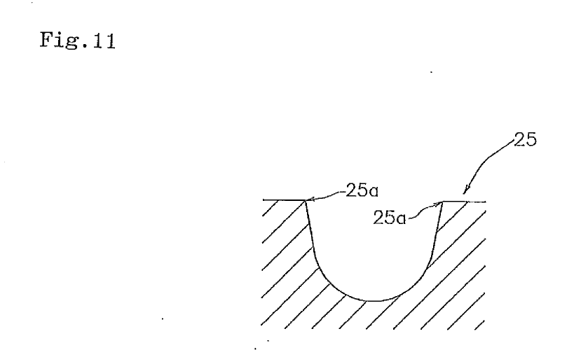

In the manufacturing step shown in FIG. 5, the plate-shaped lower mold 20 is used, however, a female type block 25 as shown in FIG. 11 may be used in place thereof. It is possible to form the bowl-shaped filter portion 11 by the female type block 25, and the male type heater block 21 shown in FIG. 6. In this case, it is preferable that a around shape is provided in an edge portion 25a. Accordingly, it is possible to prevent a defect such as a breakage of the raw material or the like.

### DESCRIPTION OF REFERENCE NUMERALS

C cup
D coffee powder
E stay space
F filter
S sheet
5 filter set portion
10 filter portion
10a bellows portion
10b flange portion
11 lid portion
11a flange portion
11b grip portion
12 wrapping paper
13 hot water pouring needle
21 heater block
22 two-piece semicircular block
24 holding block

1. A beverage use extraction filter set at a predetermined position of a beverage use extraction device, the beverage use extraction filter comprising:
a filter portion in which nonessential grocery items are accommodated; and
a tabular lid portion attached to an upper portion of the filter portion,
wherein a bellows portion is formed in the vicinity of an upper portion of the filter portion, and a bellows in said bellows portion extends, after the filter portion is set at said predetermined position and a hot water is poured via the lid portion.

2. A beverage use extraction filter as claimed in claim 1, wherein the number of stages of the bellows is at least two stages.

3. A beverage use extraction filter as claimed in claim 1 or 2, wherein said filter portion is formed as a bowl shape, and said lid portion has a flange portion having a larger diameter than an outer diameter of an upper portion of the bowl shape, and a grip portion further protruding out of the flange portion.

4. A beverage use extraction filter as claimed in any one of claims 1 to 3, wherein said lid portion is formed by an nonwoven fabric.

5. A beverage use extraction filter as claimed in any one of claims 1 to 3, wherein said lid portion is formed by a laminate film, and at least one layer is constructed by non water permeable resin film having a sealability.

6. A manufacturing method of the beverage use extraction filter as claimed in any one of claims 1 to 5, the method comprising:
a step of forming said filter portion having the bowl shape from a sheet-like raw material; and
a step of forming said bellows portion in the vicinity of said upper portion of said filter portion.

7. A manufacturing method of the beverage use extraction filter as claimed in claim 6, further comprising:
a step of filling the nonessential grocery items in the inner portion of the filter portion in which said bellows portion is formed;
a step of putting the lid portion after filling the nonessential grocery items; and
a step of packaging the beverage use extraction filter by a wrapping paper while keeping a state in which said bellows portion is formed.

8. A manufacturing method of the beverage use extraction filter as claimed in claim 6 or 7, wherein said sheet-like raw material is constructed by a nonwoven fabric having a shape memory characteristic by a heat forming.

9. A manufacturing method of the beverage use extraction filter as claimed in any one of claims 6 to 8, wherein the step of forming said bellows portion is carried out while keeping the height of said bowl shape.

10. A manufacturing method of the beverage use extraction filter as claimed in any one of claims 6 to 9, wherein the forming step of said filter portion and the forming step of said bellows portion are carried out under a higher temperature environment than a hot water pouring temperature at a time of extracting the nonessential grocery items.

11. A manufacturing method of the beverage use extraction filter as claimed in claim 8, wherein the forming step of said filter portion is carried out under a higher temperature environment than the hot water pouring temperature at a time of extracting the nonessential grocery items, and the forming step of said bellows portion is carried out under a lower temperature environment than said hot water pouring temperature.
